(19) United States
(12) Patent Application Publication
(10) Pub. No.: US 2009/0125434 A1
(43) Pub. Date: May 14, 2009

(54) Method of handling EFP transactions

(76) Inventor: Franck Rene Mikulecz, Dublin (IE)

Correspondence Address: K&L Gates LLP, STATE STREET FINANCIAL CENTER, One Lincoln Street, BOSTON, MA, 02111-2950, US

(21) Appl. No.: 11/985,052

(22) Filed: Nov. 13, 2007

(51) Int. Cl. G06Q 40/00

(52) U.S. Cl. 705/37

(57) ABSTRACT

This invention relates to a method of handling exchange for physical (EFP) transactions in a system comprising a matching host, at least one customer and at least one market maker. The method comprises the steps of the customer sending an order to the matching host, the matching host normalising the order and on finding a match to the normalised order offered by a market maker, simultaneously generating a spot transaction and a swap transaction before reporting details of the simultaneously generated spot and swap transactions. By normalising the order, the EFP transaction is handled in a very simple and efficient manner, whilst complying with all necessary and relevant regulatory requirements. Furthermore, by simultaneously generating both the spot transaction and a swap transaction to fulfill the order, the matching host fulfills the relevant regulatory requirements to carry out the EFP transaction in a manner that will stand up to subsequent scrutiny.

### FIELD OF THE INVENTION

This invention relates to a method of handling exchange for physical (EFP) transactions. More particularly, this invention relates to a method of handling EFP transactions in a system comprising a matching host, at least one customer and at least one market maker.

### BACKGROUND OF THE INVENTION

Futures contracts have been traded for many years. A futures contract is a standardised contract to buy or sell a certain item at a given date in the future at a specified price. The item may be anything from a commodity to a currency. This specification is particularly concerned with the trading of currency futures. Futures are generally traded on an exchange and the exchange's clearing house acts as counter-party on all futures contracts. Therefore, futures contracts are often seen to carry less of a risk than, for example, a forward contract and there are numerous advantages to having a futures contract rather than a forward contract. The main advantage of a futures contract over a forward contract is the protections offered by the exchange to the futures contract.

However, it is not always possible to carry out the trade during the opening hours of the exchange. If the exchange is closed, it is therefore not possible to conclude a futures contract. Trades that are made outside of the opening hours of the exchange are often referred to as “over the counter” (OTC) transactions, or “off-exchange” transactions. On the other hand, trades made through the exchange are referred to as “exchange” trades. A customer may wish to purchase a futures contract but they will be unable to do so if the exchange is closed at that moment in time. This represents a significant problem. The Commodity and Futures Trading Commission (CFTC), in recognising this problem, allows for off-exchange transactions to be converted into exchange transactions by following certain procedures. This process is often referred to as an “exchange for physical” (EFP) whereby a trade made outside the exchange can be brought into the exchange and the transformation procedure is commonly known as novation. If it is desirable or necessary to have the protections offered by the exchange, it is possible to carry out an EFP transaction and transform an OTC transaction into an exchange transaction.

Heretofore, EFP transactions have been relatively cumbersome to perform and it is an objection of the present invention to provide a method of handling EFP transactions that is relatively straightforward and efficient to perform.

### SUMMARY OF THE INVENTION

According to the invention there is provided a method of handling exchange for physical (EFP) transactions in a system comprising a matching host, at least one customer and at least one market maker, the method comprising the steps of:

the customer sending an order to the matching host;

the matching host normalising the order;

the matching host, on finding a match to the normalised order offered by a market maker, simultaneously generating a spot transaction and a swap transaction thereby fulfilling the order; and

the matching host transmitting details of the trade to the customer, the market maker and an exchange.

By having such a method, the EFP transaction may be handled in a very simple and efficient manner, whilst complying with all necessary and relevant regulatory requirements. This is achieved in part by the matching host normalising the order from the customer which transforms the order into a format that may be handled in a relatively simple manner. Furthermore, by simultaneously generating both the spot transaction and a swap transaction to fulfill the order, the matching host will satisfy the regulatory requirements to carry out an EFP transaction in a transparent manner that will stand up to subsequent scrutiny by authorities. Details of the transaction are sent to the customer, the market maker and the exchange so that all of the necessary steps to realise an EFP transaction may be carried out in one simple process rather than requiring individuals to subsequently revisit a particular trade and ensure that it is protected by the exchange.

In another embodiment of the invention there is provided a method in which the customer sends the order to the matching host in a cash basis.

In a further embodiment of the invention there is provided a method in which the customer sends the order to the matching host in a futures basis.

In one embodiment of the invention there is provided a method in which the method comprises the initial step of the matching host offering prices in both a cash basis and in a futures basis. In this way, the customer will be able to make a trade in the manner that is easiest for them, thereby facilitating the use of the method.

In another embodiment of the invention there is provided a method in which the method comprises the preliminary steps of the matching host gathering the market makers prices for spot foreign exchange (FX) and FX swaps and thereafter combining the prices together and making the combined prices available to the customer.

In a further embodiment of the invention there is provided a method in which the method further comprises the preliminary step of, subsequent to combining the prices together and prior to making the combined prices available to the customer, rounding the prices to suit a specific Futures Market convention.

In one embodiment of the invention there is provided a method in which the step of the matching host transmitting details of the trade to the customer comprises the matching host transmitting both a spot price and a futures price equivalent information to the customer.

In another embodiment of the invention there is provided a method in which the step of the matching host transmitting details of the trade to the market maker comprises the matching host transmitting a spot price information, a futures price information and a swap information to the market maker.

In a further embodiment of the invention there is provided a method in which the step of the matching host transmitting details of the trade to the exchange comprises the matching host transmitting a futures price information to the exchange.

In one embodiment of the invention there is provided a method in which the matching host transmits the details of the trade to the exchange electronically. This is seen as particularly efficient as all requirements for the EFP will be satisfied in a single process and further handling of the trade is not required thereby significantly reducing the time and risk to carry out the novation.

In another embodiment of the invention there is provided a method in which the method further comprises the step of the matching host gathering the spot FX and FX swap prices from a plurality of market makers, combining the spot FX and FX swap prices for each of the market makers and making only the best combined price available to a customer. In this way, the customer, otherwise referred to as a market taker, will not have to view the prices of a number of different market makers and will be able to avail of the best price of all the market makers that has already been gathered by the matching host. This allows for better value to be achieved by the market taker.

In a further embodiment of the invention there is provided a method in which the method comprises the preliminary steps of the matching host gathering the market maker's prices for spot foreign exchange (FX) and FX swaps and making both the spot FX and FX futures available to the customer.

### BRIEF DESCRIPTION OF THE DRAWINGS

The invention will now be more clearly understood by the following description of some embodiments thereof, given by way of example only, with reference to the accompanying drawings, in which:

FIG. 1 is a diagrammatic representation of the system in which the method according to the invention may be carried out; and

FIG. 2 is a flow diagram of the method steps of the method according to the present invention.

### DETAILED DESCRIPTION OF THE DRAWINGS

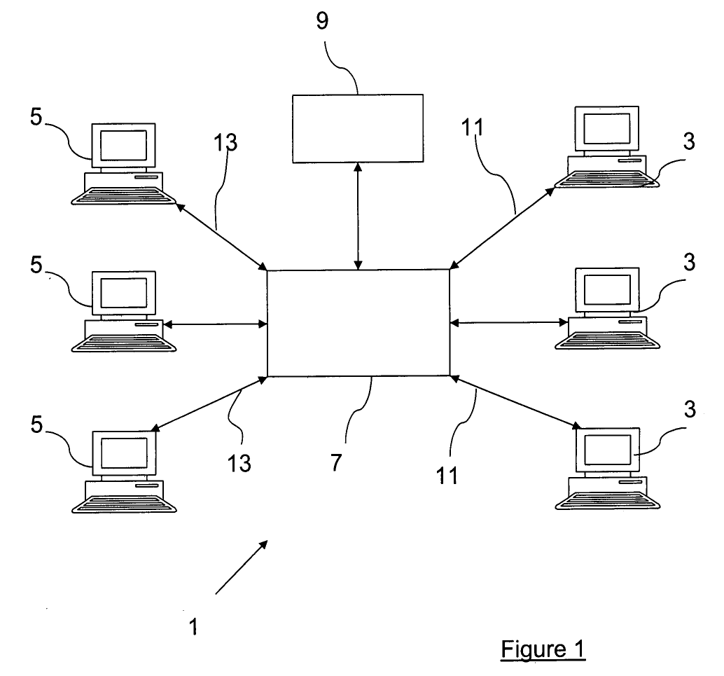

Referring to the drawings and initially to FIG. 1 thereof, there is shown a system, indicated generally by the reference numeral 1, comprising a plurality of customers 3, a plurality of market makers 5 and a matching host 7. The system further comprises a futures exchange 9. The matching host 7 is in communication with each of the customers 3 through communication links 11 which may be dedicated links such as a dedicated cable, or other shared communication links through the Internet or other communication network (not shown). Similarly, the matching host 7 is in communication with each of the market makers 5 through links 13 and the matching host 7 is connected to the futures exchange through communication link 15, which also may be either dedicated links, or other communication links through the Internet or other communication network.

In use, a customer 3 sends an order to the matching host 7. The order is an OTC order. The matching host, on receiving the order normalises the order. In order to normalise the order, the user has sent the order in either cash or futures basis, with a quantity expressed in Futures contracts. The system will transform the order to an equivalent “cash FX and forwards” order that can only then be compared and matched to the market maker orders. Once the order is normalised, the matching host attempts to find a match to the normalised order offered by one of the market makers 5. Once a match to the normalised order is found, the matching host 7 simultaneously generates a spot transaction and a swap transaction thereby fulfilling the order. The matching host 7 thereafter transmits details of the trade to the customer 3, the market maker 5 and the exchange 9. The customer is sent both the spot price and the futures price information. The market maker is sent the spot price, the futures price and the swap price information and the exchange is sent the futures price information. The exchange is also sent details including account numbers and information concerning the participants in the trade if necessary.

Preferably, the matching host 7 offers prices in both a cash basis and in a futures basis and the customer can send an order to the matching host 7 in either a cash basis or a futures basis. The matching host carries out the preliminary steps of gathering market makers prices for spot foreign exchange (FX) and FX swaps and thereafter combines the prices together and makes the combined prices available to the customer. In addition to offering or making the combined prices available to the customer, the matching host may gather this information from a plurality of market makers and either provides prices from each of the market makers to the customer, or display only the best price of all the market makers to the customer. Similarly, if desired, the matching host 7 may display, in addition to or instead of the combined price, the spot FX and FX swaps prices available to the customer. It can be seen that the information is sent to the futures exchange electronically which is a significant advantage and speeds up the process considerably. Furthermore, the entire EFP transactions may be carried out in one simple process rather than requiring revisiting of a particular trade by back-office staff, or other personnel. This simplifies the procedure of carrying the EFP transaction. Finally, the matching host will round the combined prices offered by the market makers before providing them to the market takers (customers) so that the transactions may be handled in a more efficient manner in the matching host. It is envisaged that the rounding would be done to between 2 and 5 decimal places.

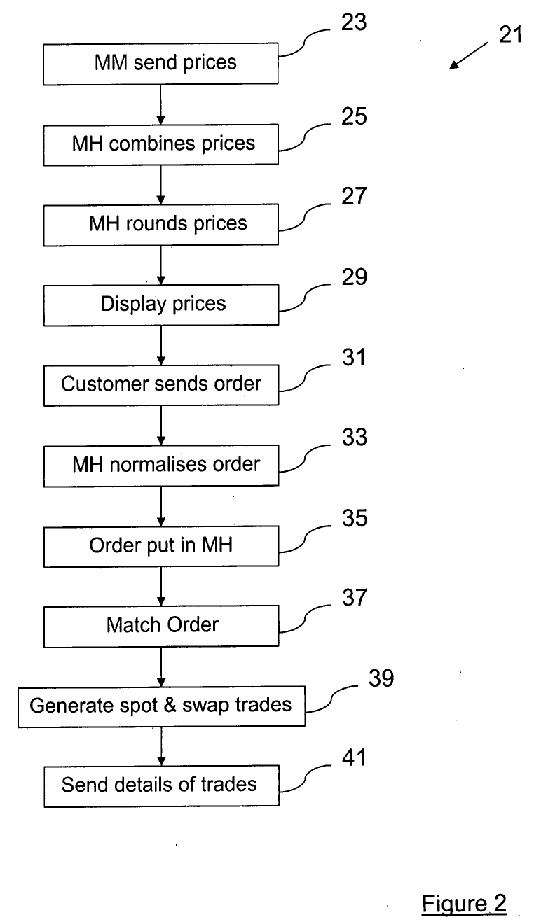

Referring to FIG. 2 of the drawings, there is shown a flow diagram of the method according to the present invention, indicated generally by the reference numeral 21. In step 23 the market makers 5 send their prices to the matching host 7. The market makers send both their spot FX and FX swaps prices to the matching host. The FX swaps are essentially forwards on the IMM dates which are the futures delivery dates, as agreed by the International Money Market (IMM) and set by the Chicago Mercantile Exchange. Typically, the matching host will receive prices from a plurality of market makers. In step 25 the matching host combines the spot FX and FX swap prices of each of the market makers. Thereby providing a futures price for that market maker. This is done for each of the market makers. The matching host then rounds each of these prices in step 27 to in this instance one decimal point and then in step 29 the matching host displays the prices of the market makers for the customers, otherwise referred to as market takers, to review. The prices are displayed online through the use of a web server (not shown) or alternatively there is a dedicated link to a server managed by the matching host that has the ability to display the information to the customers. The step of displaying prices comprises the matching host combining the various prices of each of the market makers and then determining which price offers the best value to the customer. In addition to displaying the combined price, it is envisaged that the spot FX and FX swap prices for each of the market makers will also be displayed to the customer. In this way, the customer will be able to determine the value of the deal in either spot FX prices or FX swap prices which is additional information for the customer.

In step 31, the customer sends an order to the matching host. The order may be in either spot FX basis, otherwise referred to as “cash” basis, or in “futures” basis. In step 33 the matching host normalises this order so that all orders are handled in the matching host in a single fashion rather than having some orders handled through the system in a cash basis and other orders in a futures basis. Essentially, for a cash basis order, the normalisation comprises the steps of transposing the cash basis order into a Future EFP order by adding the average Mid Forwards price available in the Matching Host to it, and converting the order size from contracts number to a number expressed in units of base currency (or Millions of it), by multiplying the number of contracts of the order with the relevant Futures contract size unit.

Therefore, it is desirable to see the size of the order in units of base currency (or millions of it), and this is achieved by multiplying the quantity of contracts the order was for, by the Futures contact size unit. Orders are most often given in numbers of contracts, for example, “Please BUY 100 contracts of December 2007 EUR-$ Futures at 1.4195 Cash Basis.” The Mid Forwards converts the price into a Futures EFP price (Spot plus Forwards). The normalisation will convert the 100 ctr. to 100×200,000=20,000,000 EUR. If the price is in Spot FX format (most common), we need to normalise it in Futures Basis, by adding the reference mid forward points of the system. Say that is 0.0042 then the Futures EFP equivalent of the order is 1.4237.

In order to normalise a futures basis order, the Futures Basis order is kept unchanged in its price attribute, but it is converted in size, similar to the above by multiplying the futures basis order contract quantity by the relevant nominal contract size so that it is expressed in base currency (or millions of it).

Once normalised, the order is put into the matching host in step 35. Preferably, the matching host will have a database (not shown) for storage of the orders and also for storage of the prices offered by the various market makers so that matches may be determined. If a corresponding offer from a market maker is in the system, the order will be matched with that offer straight-away. Alternatively, the order will stay in the system until a suitable offer to match the order is placed in the system. If after a predetermined period of time, for example one week, no market maker offer corresponding to the customer's order is available, the order may be terminated and the customer notified.

If, the order has been matched with a comparable market maker offer, the matching host matches the order in step 37 and then in step 39 the matching host generates simultaneously a spot transaction and a swap transaction for the order. By carrying out the spot transaction and the swap transaction simultaneously, this complies with regulatory requirements for converting the trade into a futures exchange trade from an OTC trade. Therefore, the spot trade and the forward trade of the swap combine to provide the futures trade. Finally, in step 41 details of the trade are sent to the customer, the market maker and the exchange. The customer is sent details relating to both the spot and futures transaction. The market maker is provided with details to both the spot and futures transaction as well as the swap information. Finally, the exchange is provided with details of the exchange for physical (EFP) transaction including futures information and account information necessary to identify the parties and the trade that has taken place. The information is sent to the exchange as well as the market maker and the customer electronically and therefore the entire process of changing an OTC to an EFP is executed in a very simple manner.

Taking a simplified example, a customer may wish to purchase a currency futures contract valued at a price of 20, the equivalent spot transaction value of that trade may be a price of 15. The customer will be able to review the prices on offer provided by the market makers, through the matching host and the customer will purchase an EFP at either a price of 15 cash basis (spot price), or 20 in futures basis. Both prices are shown to the customer and they can make the order in either futures basis or cash basis. In order to satisfy the requirements for changing an OTC into an EFP, the matching host normalises the order from the customer and then places that order onto the market. A market maker who wishes to meet the order then has the following steps carried out on his behalf by the matching host: First of all, the customer has already placed an order to buy the at a cash price of 15 and the market maker sells him the spot at 15, the system then carries out a swap at a price of 5 (the difference between the futures price and the spot price). The first leg of the swap reverses the Spot at 15 already carried out the second leg of the swap is completed by the market maker selling a Futures at 20. This forward is then converted from an OTC forward to an exchange future. In this way, rather than simply selling a future directly from the market maker to the customer, the spot transaction and the swap are carried out thereby fully satisfying regulatory requirements for an EFP transaction. The exchange is then sent details of the market maker selling the future at 20 and the customer buying the future at 20.

It will be understood that in this specification the customers, market makers, matching host and futures exchange may be located remotely from each other. For example, the customers may access the matching host through the Internet on a dedicated secure communication channel. Similarly the market makers may also contact the matching host through dedicated communication links. Therefore, both the customers and market makers may be in separate jurisdictions to the matching host. Similarly, the matching host may be in a different jurisdiction the futures exchange. Two or more of the components may be in one jurisdiction, while the other component may be in a different jurisdiction. However, it will be understood that each component will be getting the full benefit of the invention. Indeed, the matching host may further comprise a market maker itself and offer prices to the customers. The market maker is essentially a concern that offers two-way prices on a continuous basis such as a bank. Customers on the other hand may also be banks, or other concerns, but ones that do not offer prices on a continuous basis.

It is the Applicants' intention that this invention is limited to the field of currency futures and as such the specification should be interpreted in terms of currency futures and methods of dealing currency futures. The present invention is not concerned in any way with commodities futures and the like.

In the specification the terms “comprise, comprises, comprised and comprising” or any variation thereof and the terms “include, includes, included and including” or any variation thereof are considered to be totally interchangeable and they should all be afforded the widest possible interpretation.

The invention is in no way limited to the embodiments hereinbefore described which may be varied in both construction and detail within the scope of the claims.

1. A method of handling exchange for physical (EFP) transactions in a system comprising a matching host, at least one customer and at least one market maker, the method comprising the steps of:
the customer sending an order to the matching host;
the matching host normalising the order;
the matching host, on finding a match to the normalised order offered by a market maker, simultaneously generating a spot transaction and a swap transaction thereby fulfilling the order; and
the matching host transmitting details of the trade to the customer, the market maker and an exchange.

2. The method as claimed in claim 1 in which the method comprises the initial step of the matching host offering prices in both a cash basis and in a futures basis.

3. The method as claimed in claim 2 in which the customer sends the order to the matching host in a cash basis.

4. The method as claimed in claim 2 in which the customer sends the order to the matching host in a futures basis.

5. The method as claimed in claim 2 in which the method comprises the preliminary steps of the matching host gathering the market makers prices for spot foreign exchange (FX) and FX swaps and thereafter combining the prices together and making the combined prices available to the customer.

6. The method as claimed in claim 5 in which the method further comprises the preliminary step of, subsequent to combining the prices together and prior to making the combined prices available to the customer, rounding the prices to suit a specific futures market convention.

7. The method as claimed in claim 1 in which the step of the matching host transmitting details of the trade to the customer comprises the matching host transmitting both a spot price and a futures price equivalent information to the customer.

8. The method as claimed in claim 1 in which the step of the matching host transmitting details of the trade to the market maker comprises the matching host transmitting a spot price information, a futures price information and a swap information to the market maker.

9. The method as claimed in claim 1, in which the step of the matching host transmitting details of the trade to the exchange comprises the matching host transmitting a futures price information to the exchange.

10. The method as claimed in claim 1 in which the matching host transmits the details of the trade to the exchange electronically.

11. The method as claimed in claim 5 in which the method further comprises the step of the matching host gathering the spot FX and FX swap prices from a plurality of market makers, combining the spot FX and FX swap prices for each of the market makers and making only the best combined price available to a customer.

12. The method as claimed in claim 1 in which the method comprises the preliminary steps of the matching host gathering the market maker's prices for spot foreign exchange (FX) and FX swaps and making both the spot FX and FX Futures available to the customer.

13. A method of handling exchange for physical (EFP) transactions in a system comprising a matching host, at least one customer and at least one market maker, the method comprising the steps of:
the matching host offering prices in both a cash basis and in a futures basis;
the customer sending an order to the matching host;
the matching host normalising the order;
the matching host, on finding a match to the normalised order offered by a market maker, simultaneously generating a spot transaction and a swap transaction thereby fulfilling the order; and

14. The matching host transmitting details of the trade to the customer, the market maker and an exchange.

15. The method as claimed in claim 13 in which the step of the matching host transmitting details of the trade to the customer comprises the matching host transmitting both a spot price and a futures price equivalent information to the customer.

16. The method as claimed in claim 13 in which the step of the matching host transmitting details of the trade to the market maker comprises the matching host transmitting a spot price information, a futures price information and a swap information to the market maker.

17. The method as claimed in claim 13, in which the step of the matching host transmitting details of the trade to the exchange comprises the matching host transmitting a futures price information to the exchange.

18. The method as claimed in claim 13 in which the matching host transmits the details of the trade to the exchange electronically.

19. The method as claimed in claim 13 in which the method comprises the preliminary steps of the matching host gathering the market maker's prices for spot foreign exchange (FX) and FX swaps and making both the spot FX and FX Futures available to the customer.

20. A method of handling exchange for physical (EFP) transactions in a system comprising a matching host, at least one customer and at least one market maker, the method comprising the steps of:
the matching host gathering the market makers prices for spot foreign exchange (FX) and FX swaps and thereafter combining the prices together and making the combined prices available to the customer.
the matching host offering prices in both a cash basis and in a futures basis;
the customer sending an order to the matching host;
the matching host normalising the order;
the matching host, on finding a match to the normalised order offered by a market maker, simultaneously generating a spot transaction and a swap transaction thereby fulfilling the order; and

21. The matching host transmitting details of the trade to the customer, the market maker and an exchange.

22. The method as claimed in claim 19 in which the step of the matching host transmitting details of the trade to the customer comprises the matching host transmitting both a spot price and a futures price equivalent information to the customer, and in which the step of the matching host transmitting details of the trade to the market maker comprises the matching host transmitting a spot price information, a futures price information and a swap information to the market maker, and in which the step of the matching host transmitting details of the trade to the exchange comprises the matching host transmitting a futures price information to the exchange.
